(19) United States
(12) Patent Application Publication
(10) Pub. No.: US 2005/0146548 A1
(43) Pub. Date: Jul. 7, 2005

(54) Method and apparatus of operating a printer

(76) Inventors: Alejandro Manuel de Pena, Sant Cugat del Valles (ES); Santiago Garcia Reyero, San Diego, CA (US); Joan Manuel Garcia, Sant Cugat (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/971,782

(22) Filed: Oct. 22, 2004

(30) Foreign Application Priority Data
Oct. 24, 2003 (EP) 03103960.5

(51) Int. Cl. B41J 29/393

(52) U.S. Cl. 347/19

(57) ABSTRACT

An incremental printer adapted to print an image in a series of swaths, comprising a sensor adapted to determine the height of a printed swath of the image by scanning the swath as it is printed, the printer being controlled to take into account the determined height when printing a subsequent swath of the same image.

### FIELD OF THE INVENTION

This invention relates to printers. In particular, but not exclusively, it relates to printers of the type, referred to as swath printers, in which one or more printheads are mounted on a carriage which moves transversely across the width of a print medium, such as paper, the printhead(s) having an array of printing elements which usually print a swath of dots across the print medium on each traverse (“pass”) of the medium and the print medium being advanced incrementally after each pass. The invention is particularly, but not exclusively, suitable for the type of printers known as inkjet printers.

### BACKGROUND OF THE INVENTION

Inkjet printers print dots (pixels) by ejecting very small drops of ink onto a print medium (herein generically referred to as “paper”) and include a movable carriage that supports one or more printheads each having ink ejecting nozzles. The carriage traverses over the surface of the paper, and the nozzles are controlled to eject drops of ink at appropriate times pursuant to command of a microcomputer or other print controller, the timing of the application of the ink drops corresponding to the pattern of pixels of the image being printed.

The ink cartridge(s) containing the nozzles are moved repeatedly across the width of the paper. At each of a designated number of incremental positions of this movement, each of the nozzles is caused either to eject ink or to refrain from ejecting ink under the control of the print controller. Each completed movement (“pass”) across the paper can print a swath approximately as wide as the number of nozzles arranged in a column of the ink cartridge times the distance between nozzle centres. After each such completed movement or swath the paper is moved forward the height of the swath, or a fraction thereof according to the printmode selected, and the ink cartridge(s) begin the next swath (the “height” of the swath is the distance between the opposite edges of the swath measured parallel to the direction of paper movement). By proper selection and timing of the signals, the desired image is obtained on the paper.

The concept of printmodes is a useful and well-known technique of laying down in each pass of the printhead(s) only a fraction of the total ink required in each section of the image, so that any areas of paper left unprinted in each pass are filled in by one or more later passes. This tends to control bleed, blocking and cockle by reducing the amount of liquid that is on the paper at any given time.

The specific partial-inking pattern employed in each pass, and the way in which these different patterns add up to a single fully inked image, is defined by the selected printmode. Printmodes allow a trade-off between speed and image quality. For example, draft mode provides the user with readable text as quickly as possible. Presentation mode is slow but produces the highest image quality. Normal mode is a compromise between draft and presentation modes. Printmodes allow the user to choose between these trade-offs. It also allows the printer to control several factors during printing that influence image quality, including: 1) the amount of ink placed on the media per dot location, 2) the speed with which the ink is placed, and 3) the number of passes required to complete the image. Providing different printmodes to allow placing ink drops in multiple swaths can help with hiding nozzle defects. Different printmodes are also employed depending on the media type.

One-pass mode operation is used for increased throughput on plain paper. Use of this mode on other papers will result in dots which are too large on coated papers, and ink coalescence on polyester media. The one pass mode is one in which all dots to be printed on a given row of dots are placed on the paper in one pass of the printhead(s), and then the paper is advanced into position for the next swath.

A two-pass printmode is a print pattern wherein one-half of the dots available for a given row of dots per swath are printed on each pass of the printhead(s), so two passes are needed to complete the printing for a given row. Typically, each pass prints the dots on one-half of the swath area, and the paper is advanced by one-half the swath height to print the next pass as in the one pass mode. The mode may be used to allow time for the ink to evaporate and the paper to dry, to prevent unacceptable cockle and ink bleeding.

Similarly, a four-pass mode is a print pattern wherein one fourth of the dots for a given row are printed on each pass of the printhead(s). For a polyester medium, the four pass mode may be used to prevent unacceptable coalescence of the ink on the medium. Multiple pass ink-jet printing is described, for example, in U.S. Pat. Nos. 4,963,882 and 4,965,593.

In certain printmodes, for example where it is necessary to provide the ink with a relatively long drying time before the application of more ink, the printer can be operated in unidirectional mode where the printhead(s) print in only one direction of movement of the carriage, say left to right. In other printmodes the printer is operable in bi-directional mode where the printhead(s) print in both direction of movement of the carriage, i.e. both left to right and right to left. Clearly the latter allows faster printing, but possibly at the expense of image quality.

Whichever printmode is used, the paper feed mechanism must be able to accurately move the paper into position for printing, advance the paper between passes, and then eject it. The more accurately the feed mechanism can position the paper, the higher the image quality possible, especially with regard to banding at the boundary between adjacent print swaths. Banding is evidenced by repetitive variations in the optical density, hue, reflectance or any other feature which visibly delineates the individual swaths which make up a printed area. Over- or under-advance of the paper generates boundary banding, which is perceived as narrow dark or light lines within the printed area.

The nominal height of the printed ink swath corresponds to the projection of the physical height of the printhead nozzle array onto the paper. However, in practice this is combined with drop trajectory errors which increase as the printhead-to-paper distance is increased, since the area in which drops can land also increases. Thus, the actual printed swath height varies with the printhead-to-paper distance, and hence the paper thickness. It also changes with changes in the printhead height induced by thermal expansion and other possible effects.

### SUMMARY OF THE INVENTION

Accordingly, in one aspect the present invention provides an incremental printer adapted to print an image in a series of swaths, comprising a sensor adapted to determine the height of a printed swath of the image by scanning the swath as it is printed, the printer being controlled to take into account the determined height when printing a subsequent swath of the same image.

Embodiments of the invention provide a simple, fast and robust technique for dynamically adjusting the paper feed mechanism to compensate for differences between the actual printed swath height and that which should theoretically occur in the absence of errors, as determined by the printhead geometry (nominal swath height).

The invention is especially useful as swath heights increase and dot placement error margins continue to decrease (currently some printing systems require tolerances as low as 5 um), since small swath height variations become especially apparent and can limit overall printer performance. As a result, paper feed errors must be adjusted to these variations and kept to a minimum.

Other aspects and advantages of the invention will be apparent from the following description and claims.

### BRIEF DESCRIPTION OF THE DRAWINGS

Preferred embodiments of the invention will now be described, by way of example, with reference to the accompanying drawings, in which:

FIG. 1 shows an embodiment of a printer according to the present invention.

FIG. 2 is a close-up, diagrammatic cross-sectional view of the carriage portion of the printer of FIG. 1.

FIG. 3 is a block diagram of a print control circuit which controls the operation of the mechanical and electrical components of the printer of FIG. 1.

FIG. 4 is a flow diagram of a swath height correction routine implemented by the print control circuit of FIG. 3.

FIG. 5 is a graph showing the difference between a measured printed swath height and a nominal swath height.

### DETAILED DESCRIPTION OF AN EMBODIMENT OF THE INVENTION

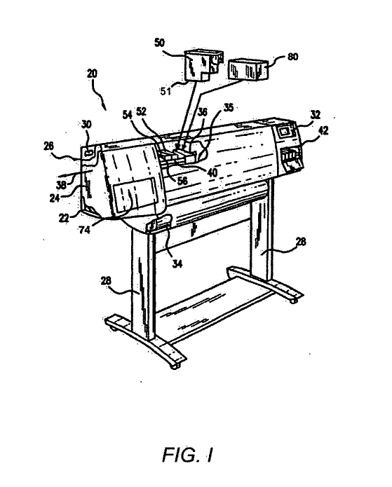

Referring to FIG. 1, the printer 20 includes a chassis 22 surrounded by a housing 24, together forming a print assembly portion 26 of the printer 20. The print assembly portion 26 may be supported by a desk or tabletop; however, it is preferred to support the print assembly portion 26 with a pair of leg assemblies 28. The printer 20 also has a print controller 30, illustrated schematically as a microprocessor, that receives image data from a host device (not shown), typically a computer, such as a personal computer or a computer aided drafting (CAD) computer system. The print controller 30 may also operate in response to user inputs provided through a key pad and a status display portion 32, located on the exterior of the housing 24.

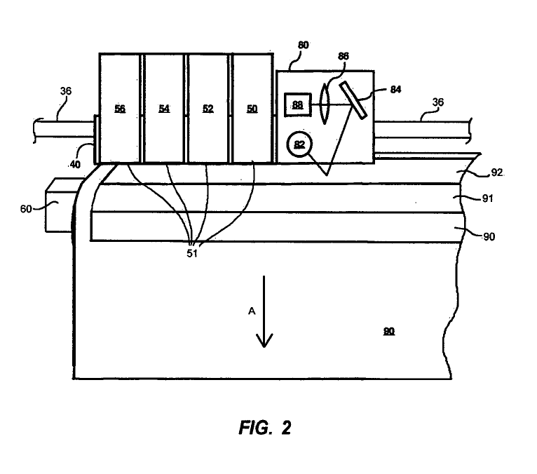

A conventional paper feed mechanism 60, FIG. 2, is used to advance a continuous sheet of paper 90 from a roll 34 through a print zone 35 under the control of the print controller 30. Alternatively, the printer 20 may be used for printing images on pre-cut sheets, rather than on paper supplied on a roll 34. Although referred to herein generically as paper, the print medium may be any type of suitable sheet material, such as paper, poster board, fabric, transparencies, mylar, vinyl and the like. A carriage guide rod 36 is mounted on the chassis 22 to define a scanning axis 38, with the guide rod 36 slidably supporting a carriage 40 for travel back and forth across the print zone 35. A conventional carriage drive motor (not shown) is used to propel the carriage 40 under the control of the print controller 30. The scanning axis 38 is orthogonal to the direction of paper feed indicated by the arrow in FIG. 2.

To provide carriage positional feedback information to controller 30, a conventional metallic encoder strip (not shown) may extend along the length of the print zone 35 and over a servicing region 42. A conventional optical encoder reader (not shown) is mounted on the back surface of the carriage 40 to read positional information provided by the encoder strip. The manner of providing positional feedback information via an encoder strip reader is well known to those skilled in the art.

The printer 20 contains four print cartridges 50-56, which are mounted on the carriage 40 (the cartridge 50 is shown removed from the carriage in FIG. 1, but in use it will be seated in the carriage next to the cartridge 52 as shown in FIG. 2). In the print zone 35, the paper 90 receives ink from the cartridges 50-56. The cartridges 50-56 are also often called “pens” by those in the art. One of the pens, for example pen 50, may be configured to eject black ink onto the paper 90, while pens 52-56 may be configured to eject different coloured inks such as yellow, magenta and cyan respectively.

The printer 20 uses an “off-axis” ink delivery system, having main stationary reservoirs (not shown) for each ink (black, yellow, magenta, cyan) located in an ink supply region 74. In this respect, the term “off-axis” generally refers to a configuration where the ink supply is separated from the cartridges 50-56. In this off-axis system, the pens 50-56 are replenished by ink conveyed through a series of flexible tubes (not shown) from the main stationary reservoirs so only a small ink supply is propelled by carriage 40 across the print zone 35. However, the invention is equally applicable to a printer wherein each pen contains its own reservoir of ink and is replaceable as a unit when the ink in the cartridge has run out.

The pens 50-56 have respective printheads 51 which selectively eject ink to form an image on paper 90 in the print zone 35. These printheads in this embodiment are quite long, for instance about 22.5 millimetres long or more, although the invention may also be applied to shorter printheads. The printheads each have an orifice plate with a plurality of nozzles formed therethrough in a manner well known to those skilled in the art.

The nozzles of each printhead are typically formed in an array of at least one row, but more usually two staggered rows, along the orifice plate (not shown), the row(s) extending in a direction orthogonal to the scanning axis 38. The length of each array determines the nominal image swath height for a single pass of the printhead.

The print controller 30 is arranged to control and coordinate the operation of the paper feed mechanism 60, the carriage drive mechanism and the inkjet nozzles of the printheads 50-56 such that a desired image may be built up incrementally swath-by-swath on the paper 90 in one-pass or multi-pass mode, and in unidirectional or bi-directional mode, as previously described, according to the requirements of the job to be done. For simplicity FIG. 2 shows the printer operating in one-pass unidirectional mode, the full height of successive swathes 90-92 being printed during successive right to left passes of the carriage and (subject to error) placed on the paper 90 side-by side in non-overlapping abutment.

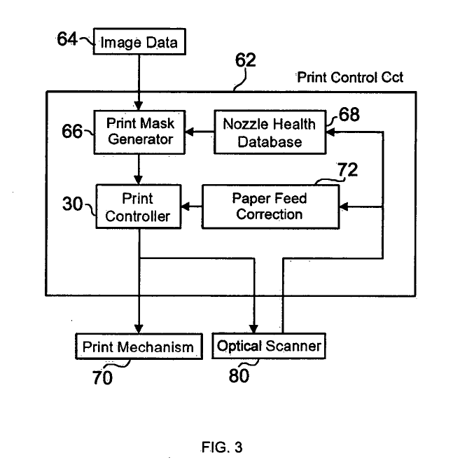

The manner in which the print controller 30 operates is well-known to those skilled in the art, but will be briefly described with reference to FIG. 3 which is a schematic block diagram of a print control circuit 62 of which the print controller 30 forms part (it will be understood that although various functional blocks are shown as separate modules in FIG. 3, in practice these functions are implemented by a suitably programmed microprocessor and associated memory).

Image data 64 is received in a standard format (e.g. tiff) by the print control circuit 62 from a computer, scanner or other external device. This data is converted into a print mask by a print mask generator 66. A print mask is a binary pattern that determines exactly which ink drops are printed in each pass by which nozzles. In an N-pass printmode, each pass should print, of all the ink drops to be printed, a fraction equal roughly to the reciprocal of N. The print mask is thus used to “mix up” the nozzles used, as between passes, in such a way as to reduce undesirable visible printing artefacts. The print mask generator 66 is responsive to a nozzle health database 68. The latter stores indications of blocked or misfiring nozzles, and in generating the print mask the generator 66 can, in the case of nozzle redundancy, substitute properly working nozzles for faulty nozzles. This concept and its implementation are well-known in the art. Finally, the print mask is used by the print controller 30 to control and coordinate the operation of the mechanical and electrical components of the print mechanism 70, that is to say, the paper feed mechanism 60, the carriage drive mechanism and the inkjet nozzles of the printheads 50-56.

As discussed above, to obtain a high quality image it is desirable that the paper feed mechanism 60 advance the paper 90 through a distance equal to the height of a swath, or fraction thereof depending on the printmode, after each pass of the carriage 40. In this embodiment this is achieved using an optical scanner 80 which is mounted on the carriage 40 immediately adjacent to the pen 50.

In this embodiment the term “optical scanner” means a device having an array of light sensitive elements (“photodetectors”) each providing a signal whose amplitude is a function of the amplitude, duration and, where the photodetector is colour-discriminant, the colour of light falling on it. Such devices, which are usually based upon photodiodes and charge coupled devices (CCDs), are well-known in flat bed scanners and the like which are used to capture images from a printed media for use in, for example, computing devices; see, for example U.S. Pat. No. 6,037,584. In the present context, the terms “light” and “optical” are intended to include ultraviolet light.

The optical scanner 80 is mounted on the carriage 40 in such a manner that the optical scanner can scan slightly more than the full height of each right-to-left swath as it is printed. Clearly the optical scanner is only capable of scanning left-to-right swaths as they are printed since only in that direction of movement does the optical scanner trail the printheads. However, if the scanner were mounted adjacent to the pen 56 then it would be capable of scanning each left-to-right swath as it is printed. It is immaterial to the invention which direction is used. The scanner 80 is arranged to scan slightly more than the full swath height to ensure that undesired variations in swath height do not cause the edges of the swath to fall outside the field of view of the scanner.

In general, in this embodiment, the optical scanner 80 may comprise any reasonably suitable, commercially available charge coupled device (CCD) scanner. Although it may be convenient to mount the scanner to the carriage 40, the skilled reader will appreciate that in other embodiments this need not be the case. The optical scanner 80 includes a light source 82, one or more reflective surfaces 84 (only one reflective surface is illustrated), a light focusing device 86, and a CCD 88. The optical scanner 80 captures images by illuminating the images with the light source 82 and sensing reflected light with the CCD 88. The CCD 88 may be configured to include various channels (e.g., red, green and blue) to detect various colours using a single lamp or a one channel CCD (monochrome) with various colour sources (e.g., light emitting diodes). A more detailed description of the manner in which the CCD 88 may operate to detect pixels of an image may be found in U.S. Pat. No. 6,037,584 referred to above.

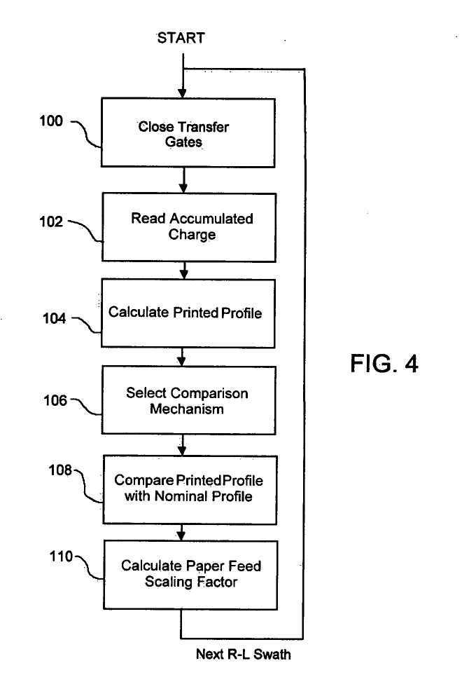

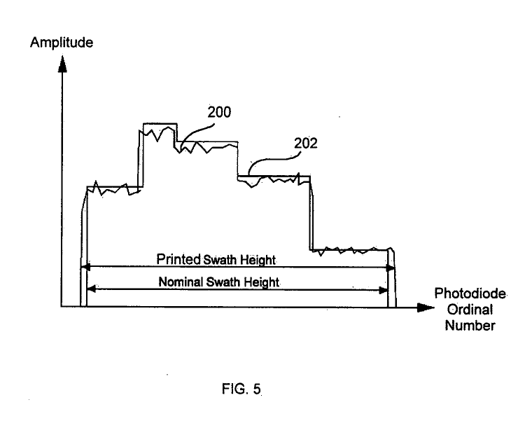

The optical scanner 80 is operable in this embodiment in either one of two modes, selected by the print controller 30. In a first, calibration mode, the scanner is operable to scan test patterns on the paper 90 to determine the presence and location of faulty inkjet nozzles, this information being used to construct the nozzle health database 68. This mode of operation is the subject of our copending U.S. patent application Ser. No. 09/984937 (HP 60015794-1), the disclosure of which is incorporated herein by reference, and will not be further described here. In the second mode of operation, scanned image data from the optical scanner 80 is input to a paper feed correction routine 72 in the print control circuit 62 to adjust the paper feed mechanism to compensate for any difference between the actual printed swath height and a nominal swath height. That mode will now be described with reference primarily to FIGS. 4 and 5.

As described in U.S. Pat. No. 6,037,584, and in particular FIG. 2 thereof, the optical scanner 80 comprises three rows of photodiodes sensitive to red, green and blue light respectively, each row having an associated CCD analog shift register and the photodiodes in each row being connected via a transfer gate to respective storage locations in the associated shift register. Each row of photodiodes has a resolution greater than the resolution of the printhead nozzles (i.e. there are more photodiodes per millimetre than nozzles in the direction orthogonal to the axis 38) and each row has a field of view extending over slightly more than the nominal swath height (the nominal swath height is the height of the right projection of the inkjet nozzles onto the paper).

In the second mode, at the start of printing each right-to-left swath the transfer gates are closed (Step 100) and held closed for substantially the full length of the swath so that each photodiode accumulates a charge as the scanner 80 scans the swath being printed. Since each photodiode only “sees” a very small fraction of the total height of the swath, effectively a very narrow line parallel to the swath edges, the amplitude of the charge accumulated by each photodiode at the end of the swath is a function of the colour, intensity and distribution of pixels along the line of the swath scanned by that photodiode.

At the end of printing the swath the transfer gates are opened so that the charge accumulated on each photodiode is transferred into the respective storage location of the associated CCD shift register. In each shift register the contents of the storage locations are now read out serially, analog-digital converted, and input to the paper feed correction routine 72 (Step 102).

It will be evident that when the amplitudes of the charges from any one of the rows of the photodiodes is plotted against the ordinal number of the photodiode in the row, as seen in FIG. 5, a graph 200 is produced which is effectively a profile of the actual printed swath as seen by that row of photodiodes (in FIG. 5, each point of inflection corresponds to the amplitude of the accumulated charge on a respective photodiode). It will also be evident that the print control circuit 62 “knows” what the nominal swath profile is, i.e. what the printed profile would be in the absence of errors, since this can readily be derived from the print mask. The nominal swath profile 202 corresponding to the actual printed profile 200 is also shown in FIG. 5. By comparing the two profiles, the difference between the printed swath height and the nominal swath height can be calculated, and a scaling factor passed to the print controller 30 to adjust the amount by which the paper is advanced to correspond with the actual, rather than the nominal, swath height. All this is done by the routine 72.

First, therefore, the printed swath profile is calculated (Step 104). This can be based on the accumulated charges from just one row of photodiodes, preferably the green-sensitive row in the case of black text on white paper. Alternatively, the signals from the three photodiodes in the same ordinal position in their rows can be added together to give an amplitude value for each ordinal position of the photodiodes. The printer control circuit can choose the method most likely to give a distinctive swath profile for the particular image concerned.

Next a comparison mechanism is selected (Step 106). It will be recognised that FIG. 5 is a highly idealised graph, and that in practice few profiles will have such distinctive steps and edges. In fact, only lines of monochrome text are likely to show such edges. Also, FIG. 5 shows just a single swath, and in practice the swath will abut or overlap adjacent swaths, depending on the printmode, so that distinctive vertical edges will not necessarily be seen at the trailing edge of the swath (the leading edge will always be seen since it is printed on virgin paper). Therefore, the routine 72 selects the most appropriate comparison mechanism. In the case of a profile having reasonably clear features, a relatively simple pattern matching algorithm will be sufficient. In other cases, for example multicolour graphics, a more sophisticated correlation algorithm would be used.

Next the actual comparison is made (Step 108) and from this a scaling factor for the paper feed mechanism is calculated (Step 110). As stated, the scaling factor is passed to the print controller 30 to adjust the amount by which the paper is advanced to correspond with the actual, rather than the nominal, swath height. The paper advance may be a full swath height in the case of one-pass printing, or a fraction of the swath height in the case of multi-pass printing, but in each case the full swath height, or the fraction, will be based upon the actual printed swath height. After Step 110 the routine loops back to the start in preparation for the next right-to-left print swath.

Due to the position of the optical scanner 80 on the right of the cartridge 50, FIG. 2, the actual printed swath height cannot be determined for right-to-left printed swaths. Therefore, in bi-directional printing the paper feed can be adjusted only on alternate swaths. However, this is quite acceptable since significant changes in swath height are not likely to occur on a swath by swath basis. Indeed, it is possible to ascertain the actual printed swath height less often than that; say once every four swaths.

Modifications of the above embodiment are possible. For example, it may not be necessary to optically scan the full height of the swath provided the part that is chosen provides a printed swath profile having distinctive features which can be matched or compared with corresponding features in the nominal swath profile. This is because Step 110 calculates a scaling factor, and this can be derived from part only of the full swath height. However, the part that is chosen preferably includes the leading edge of the swath, since this will always give a definite reference point.

Also, it is not necessary to accumulate charge along the entire length of the swath, although in general the greater the length of the swath which is optically scanned the more distinctive the profile.

Although the foregoing has described embodiments of the invention in which swath height errors are corrected by adjusting the amount by which the print medium is advanced between swaths, other compensation techniques can be used. For example, the specification of our copending EP Patent Application No. 03101194.3 (HP 600205021-1), entitled “Hardcopy apparatus and method”, describes an incremental printer in which the print medium is advanced between consecutive swaths by a distance slightly less than the height of the printhead so that in each pass the trailing nozzles of the printhead pass over the same region of print medium as the leading nozzles in the previous pass. In such a case banding between consecutive swaths is mitigated by depletion or propletion of the number of nozzles used in the overlap region. The same technique can be used to compensate for swath height errors in the present invention.

The invention is not limited to the embodiment described herein and may be modified or varied without departing from the scope of the invention.

1. An incremental printer adapted to print an image in a series of swaths, comprising a sensor adapted to determine the height of a printed swath of the image by scanning the swath as it is printed, the printer being controlled to take into account the determined height when printing a subsequent swath of the same image.

2. A printer as claimed in claim 1, wherein the printer feeds a print medium relative to a printhead in accordance with the determined height.

3. A printer as claimed in claim 1, wherein the sensor is mounted on a printhead carriage which moves transversely across the print medium to print successive swaths.

4. A printer as claimed in claim 1, wherein the sensor comprises an optical scanner having an array of photodetectors arranged to scan at least a part of the swath height as the swath is printed, each photodetector scanning along a line of the swath parallel to the swath edges.

5. A printer as claimed in claim 4, wherein a print controller enables the optical scanner, for at least selected swaths, to scan at least a part of the swath length as it is printed to provide an accumulated signal in respect of each photodetector resulting from the line of the swath scanned by that photodetector, the amplitudes of the signals collectively defining a printed swath profile, the print controller being arranged to compare the printed swath profile with a nominal swath profile to determine the height of the printed swath.

6. A printer as claimed in claim 1 or wherein the part of the swath height scanned by the optical scanner includes the leading edge of the swath.

7. A printer as claimed in claim 1 or wherein the optical scanner scans the full swath height.

8. A printer as claimed in claim 1 or wherein the optical scanner scans substantially the full swath length.

9. A printer as claimed in claim 1 or wherein the printer is adapted for bi-directional printing and the selected swaths are those where the direction of movement of the carriage is such that the optical scanner trails the printhead.

10. A printer as claimed in claim 1, wherein the printer is adapted for multi-pass printing whereby the print medium is advanced a predetermined fraction 1/N of a swath height at a time so that N passes are necessary to complete a swath-high portion of the image.

11. A printer as claimed in claim 5, wherein the actual and nominal swath heights are compared by pattern matching.

12. A printer as claimed in claim 5, wherein the actual and nominal swath heights are compared by correlating one with the other.

13. A printer as claimed in claim 1, wherein the printer is an inkjet printer.

14. A method of operating an incremental printer adapted to print an image in a series of swaths, comprising using a sensor to determine the height of a printed swath of the image by optically scanning the swath as it is printed, and controlling the printer to take into account the determined height when printing a subsequent swath of the same image.

15. A control circuit for an incremental printer, the circuit being adapted to control the printer to perform the method claimed in claim 14.

16. A computer readable medium containing program instruction which, when executed by a data processing device, perform the method claimed in claim 14.
